(19) United States
(12) Patent Application Publication
(10) Pub. No.: US 2009/0095164 A1
(43) Pub. Date: Apr. 16, 2009

(54) METHOD OF ENHANCING BEVERAGES BY MEANS OF A UNIQUE MICROENCAPSULATED DELIVERY SYSTEM

(76) Inventor: Salvatore Albert Celeste, Peabody, MA (US)

Correspondence Address: MORSE, BARNES-BROWN & PENDLETON, P.C.;ATTN: IP MANAGER, RESERVOIR PLACE, 1601 TRAPELO ROAD, SUITE 205, WALTHAM, MA, 02451, US

(21) Appl. No.: 12/121,809

(22) Filed: May 16, 2008

Related U.S. Application Data
(60) Provisional application No. 60/930,586, filed on May 17, 2007.

(51) Int. Cl. A47J 31/40; A47J 31/06

(52) U.S. Cl. 99/285; 99/279; 220/87.1

(57) ABSTRACT

The present invention provides a method of imparting flavor enhancers, (flavorings) flavor or aroma masking agents, medicinal additives, fragrances, vitamins, colorants, homeopathic and herbal remedies, appearance and characteristic modifiers and other ingredients to a brewed or steeped beverage such as coffee or tea by means of a microencapsulated delivery system incorporated onto a substrate or filter material such as those used in drip coffee makers or tea bags. The microcapsules are “printed” or laminated to the substrate filter paper in a pattern that allows water to pass through while the microcapsules filled with a flavoring liquid or solid is dissolved thus releasing the contents into the water stream resulting in a flavor-enhanced beverage. Alternative delivery may also be achieved by means of:
a) A microcapsule coated paper disc that may simply be immersed in the hot beverage or;
b) A microcapsule coated interior wall of a disposable container or cup (A paper coffee cup for example) until such time the hot fluid within the container dissolves the microcapsules thus releasing the latent additive ingredient or a primary formulation of ingredients constituting the entire beverage solution or mixture.
   Several variations of this technology may be adapted for use with hot, cold or ambient temperature beverage preparation methods. Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings, photos and description are to be regarded as illustrative in nature and not restrictive.

### BACKGROUND OF THE INVENTION

1. Field of the Invention

This invention relates generally to flavorings, pharmaceuticals, herbal remedies, medicinal preparations, cosmetics, analytical indicators, food and beverages additives, and more particularly the latent release of these materials by means of a unique, printable, microencapsulated delivery system.

2. Background Art

Various methods have been developed for the preparation of “instant” beverages or the subsequent addition of flavorings or other ingredients after the beverage has been prepared. As an example, the brewing of coffee and tea and most notably the automatic drip coffee maker. This apparatus heats and regulates the passage of water through a permeable filter containing the ground bean solids while simultaneously imparting the extracted oils and flavors of the fractionated coffee bean into the water flow thus creating a coffee-flavored beverage. Similarly, when preparing tea, a bag or envelope of filter material is used to contain the leaf solids while the flavor is extracted from the ground tea leaf while being steeped in hot water. Currently, if additional flavoring such as a spice or herb is desired, one must purchase a pre-flavored quantity of the desired preparation or attempt to add the ingredient after brewing. Further, if one desires a premium flavor or more full-bodied roast, a quantity of that blend must be purchased as well. These additives and premium roasts are expensive and tend to have limited shelf-life, often spoiling before the purchased quantity can be reasonably consumed by an individual. One purpose of this invention is to provide a convenient means in which a beverage may be prepared in its entirety or additional additives may be imparted to a pre-existing beverage by means of a latent release of microencapsulated ingredients that provide some additional desirable characteristics to the beverage when the microcapsules are combined with, or otherwise contacted by a fluid. This could be the addition of flavorings, minerals, vitamins, condiments, colorings, herbs, spices or medicinal ingredients. Another purpose of this invention is to provide a method of “instant” preparation of a variety of beverage components in which the primary constituents of a beverage are encapsulated and affixed to substrate such as a filter, sheet or interior wall of a container. When water or other appropriate liquid is introduced into the system, the fluid dissolves the microcapsules releasing the constituent components into the solvent thus creating a new beverage instantly. Yet another purpose of this invention, while maintaining exactly the same design features and physical characteristics, can be applied to an entirely different but equally useful function. That is, to enhance the utility and convenience of use of many medicinal preparations such as vaccines, pharmaceuticals as well as a variety of analytical indicators such as those employed for urinalysis and pregnancy testing. Additional adaptations can be envisioned for the sanitizing or removal of undesirable compounds in liquids. This would include but is not limited to, the removal of microorganisms by means of latent release of antimicrobials to make impure water potable or alternatively, the removal of chemical compounds such as chlorine from water utilizing the latent introduction of chlorine scavengers such as potassium nitrate or lithium carbonate to improve taste. Several applications within the scope of this invention may or may not require the microcapsule membrane to rupture but simply be permeated to a point of equilibrium with the surrounding fluid. Further obvious embodiments can be foreseen that would benefit from this technology including binary adhesives such as two-part epoxies and binary disinfectants that require latent activation.

### DESCRIPTION OF THE PREFERRED EMBODIMENT

One of the preferred embodiments of the present invention consists of a section of filtration paper with sufficient porosity for brewing heated beverages such as coffee or tea, having the ability to retain the organic solid but permeable to the filtrated liquid. A coffee filter used in drip-type automatic coffee makers is a typical example of such a filter. The filter, being “cup” or “basket” shaped, having a round flat bottom and pleated sides is used as the substrate for one application of the flavor delivery system. The delivery system consists of a plurality of gelatin microcapsules (Or other suitable food-grade encapsulation polymers) filled with concentrated additive ingredients in liquid or solid form. The capsules are created by means of complex or simple coacervation using gelatin or gelatin with acacia gum as the wall or “outer-phase” material. Both of these methods of encapsulation are generally well known to anyone skilled in the art. In addition to the preceding technique, many alternative methods of encapsulation will also yield acceptable microcapsules such as spray drying, ultrasonic cavitation, coaxial extrusion and others that would be considered suitable for human consumption depending on cost, application, physical characteristics and compatibility with the material to be encapsulated.

Once the microcapsules are fully formed, they are cleaned and separated from the liquid suspension. The capsules are typically homogenous and can range in size from 50 to 2500 microns in diameter or larger if required to accommodate delivery volume. In one preferred embodiment, the finished capsules are “silk-screened” onto a coffee-filter substrate to form a pattern of clustered microcapsules as shown in FIG. 1. This pattern is used to permit some of the water to flow through the filter unimpeded by the microcapsules to prevent an overflow condition during the brewing process. This is necessary until the majority of microcapsules have dissolved to such a degree as to allow the water to pass through the filter membrane where the microcapsules were previously deposited. These patterns may be altered to form text, images and logos if desired. FIG. 2 The pattern may also be modified to increase or decrease the relative strength of the additive. FIG. 3 shows a magnified view of the microcapsules formed into patterned clusters while FIG. 4 depicts a close-up view of the individual fluid filled microcapsules in aggregate clusters as they appear on the filter material surface. The microcapsules are of sufficient structural strength to allow for many different methods of application to the filter paper, including but not limited to, inkjet printing, offset printing, screen printing through a pattern mask and spray coating. The wet capsule slurry is then dried causing the shells of the microcapsules within the clusters to harden sufficiently to be handled. Only when re-hydrated and dissolved with hot water will the microcapsules release the encapsulated inner-phase components. Similar results may be obtained using different filter geometries such as cone-type or “Melitta” filters FIG. 5 provided the microcapsules are within the internal portion of the filter material that becomes wetted during the brewing cycle. This also applies to “tea bags” and other flavor extraction methods using heated fluid or steam as the primary preparation process. This invention can also be used to impart additives to other beverages such as hot apple cider, hot chocolate or any other heated beverage that would benefit from a latent flavoring technique such as this by means of application of the microencapsulated ingredients onto a filter or paper substrate during preparation or onto the internal walls of the serving container from which the beverage may be consumed. Many release or “trigger” methods may be conceived and implemented provided that the system fluid or the method in which it is prepared provides conditions that will cause the microcapsules to fail and release the core material. Two simple examples of this would be capsule wall degradation by means of a change in pH or molecular phase. For example:
1. An acidic beverage such as orange juice coming in contact with a wall material that dissolves or destabilizes in the presence of a weak acid.
2. Rupturing of the microcapsule wall due to expansion of the inner-phase material. Specifically, the introduction of any fluid having a sufficient temperature differential, hot or cold, relative to the encapsulated ingredient that would cause the core material to expand beyond the confines of the capsule envelope ultimately resulting in a catastrophic loss of membrane integrity.

### DETAILED DESCRIPTION

The utility of this invention becomes readily apparent when one considers that;

As an alternative to purchasing large and sometimes expensive volumes of flavored coffee such as a “pound of hazelnut” that may not be used quickly enough to avoid the remainder becoming stale, this invention allows the user to flavor one pot or cup at a time using standard unflavored coffee roasts. For instance, if the filters, as described within the scope of this invention were provided in a multiplicity of flavors such a cinnamon, hazelnut or almond, then the user need only to purchase a single unflavored roast coffee and would be able to make a pot of whichever flavor is desired without having to purchase three large volumes of pre-flavored coffee that may not be completely consumed within the recommended shelf-life period of the coffee. In another example, the user may be provided with filters that contain microencapsulated extracts of superior coffees such as “Kona” or other richer, more expensive blends. Rather than buying the more expensive roast in quantity, the user may impart the essence of the more expensive roast into lower grades of coffee such as that available in retail cans. This technology can be used to add most any additive to almost any beverage. One example is creating a “spice filter” specifically for use with ciders. Spices are imparted to the cider as it passes through an appropriately flavored filter. In addition, many otherwise perishable ingredients that would normally be unsuitable for storage at room temperature would be protected from spoilage within the barrier provided by the microencapsulation. Many other obvious applications can be foreseen provided that the beverage, medicinal preparation or liquid can benefit from the latent release of the additive substance.

Examples include: An immersed filter envelope of similar configuration in water to prepare or steep tea. The interior of the “teabag” envelope is prepared with a similar microcapsule delivery system thus imparting flavors, herbal remedies such as chamomile or medicinal substances such as aspirin to the tea upon contact with the heated water as shown in FIG. 6.

### Example 1

Coffee/Beverage Filter: In broad terms, this embodiment of the invention is comprised of the following steps:

In this embodiment we will use complex coacervation as the preferred method of encapsulation although many other methods can be used such as spray drying, Wurster coating, fluidized bed or co-extrusion to name a few. Cinnamon shall be used as the example additive although many others such as hazelnut, almond or Baileys may be used. A quantity of high bloom porcine or bovine gelatin having a 250 bloom strength or greater (The preferred first polymer) is dissolved in a volume of water. An equal quantity of gum arabic (The co-polymer) is dissolved in an equal volume of water. The pH of the sols will be approximately (6.0-8.0) at 25 degrees centigrade. Next, a suitable quantity of the concentrated additive, preferably an oil-based extract, (The “inner-phase” material) is added to either of the aforementioned sols to form an emulsion. With moderate agitation, the second sol is then added to that of the first sol/emulsion. Once both are mixed, the agitation will begin to form droplets of the oil extract rather than form a layer of oil or hydrophobic material. Once the droplets are divided into a suitable size, (Typically between 50-2500 μm in diameter or larger) the stirring is continued but not so fast as to decrease, or too slow to increase the size of the droplets. The pH is then reduced to approximately 4.5 and the temperature of the material is increased to approximately 45 degrees centigrade. When the pH reaches 4.5, there will be a noticeable “clouding” of the solution. This flocculation of the polymer indicates that the coacervate is forming around the oil droplets. That is to say that a layer of gelatin and gum-arabic (This layer is referred to as the outer-phase material or complex polymer) is forming a shell around the oil-based additive. Once the shell is of sufficient thickness and all of the available coacervate has enveloped the oil phase, then the sol is rapidly cooled in a bath of chilled water to about 5 degrees centigrade. At this point, the liquid complex-polymer wall solidifies trapping the additive within the newly formed microcapsule. FIG. 7 The pH is then adjusted to above 6.0 to avoid the possibility of further coacervation. Adjustments of pH can be achieved with weak solutions (5-10%) of acetic acid or sodium hydroxide dependent upon the pH change required. If needed, further polymerization can be achieved by means of several common cross-linking agents such as gluteraldehyde. However, in this particular instance a sufficient but relatively weak cross-linking occurs due to the naturally occurring aldehydes (cinnamaldehyde) already present in the cinnamon flavoring. Further cross-linking is usually not necessary with most other additives if the outer-phase material used forms a solid at room temperature. The microcapsules are then placed in a centrifuge or separation funnel, rinsed with water and drained. This will form a slurry of relatively uniform, spherical, liquid-filled microcapsules. These microcapsules may now be dehydrated to a free-flowing powder and stored or may be used as is. They may also be stored in the slurry state. The outer capsule will increase the shelf-life of the additive, protecting flavor and other efficacious characteristics by providing a barrier against contamination or microbial infestation until suitable conditions are met to cause the release of the inner-phase material.

Next, the slurry may be applied to the filter-paper substrate using a perforated mask or “screen”. See FIG. 8. The process is very similar to silk-screening except that the perforations are of a size that will allow the microcapsules to pass through the mask to be affixed onto the substrate below. The perforations are typically 0.066″ to 0.125″ in diameter in order to form suitable clusters with sufficient additive to flavor an entire pot (12 cups) of coffee. A suitable masking material is Teflon-coated, perforated HDPE. After the capsule slurry is drawn across the perforated mask using a squeegee device, the mask is removed and the filter paper is allowed to dry. The outer-phase material will generally adhere to the substrate surface upon drying. However, if necessary, a separate binder of starch, albumin or other edible adherent may be used. Once dehydrated, the capsules will harden with sufficient wall strength to be handled normally without inadvertent breakage of the otherwise frangible capsules. The capsules, at the time of manufacture and prior to screening may be colorized and then applied in a decorative pattern, text, image or logo FIG. 2 when printed onto the filter. The filter is now ready for use.

The filter is then placed into the automatic drip coffee maker and filled with the appropriate amount of ground coffee of a presumably unremarkable grade. The coffee is brewed in the usual way. As the hot water begins to filter through the coffee, it begins to dissolve the gelatin shells of the microcapsules affixed to the filter wall thus slowly releasing the flavoring additive into the coffee flow. The empty microcapsule shells are mostly dissolved and remain in the filter with the spent coffee bean granules. The cinnamon flavoring has now been successfully imparted into the coffee beverage. The filter and its contents may now be discarded. In addition to flavorings, other characteristic enhancing materials may also be incorporated into the filter. This may include but is not limited to materials for the removal of chlorine and other contaminants, pH modifiers to improve taste or additives to enhance or change the appearance or physical characteristics of the brewed beverage.

### Example 2

Flavor disc: In broad terms, this next preferred embodiment of the invention is comprised of the following steps:

This embodiment is prepared identically as in Example 1 with the exception that the substrate is a paper disc or other desired shape having a pattern or coating of the microencapsulated additive applied thereto. FIG. 9 shows several examples of disc-shaped pattern configurations with 0.066″ to 0.125″ diameter clusters across the entire surface of the discs. This device would simply be immersed in the beverage just prior to consumption for a sufficient period of time to allow the microcapsules to dissolve thus delivering the interior phase component (s). These discs could be configured to also deliver flavors, fragrances, characteristic modifiers, colorants, vitamins and other medicinal ingredients to a variety of liquid beverages, hot or cold.

### Example 3

Cosmetic and Cosmeceutical Applicator Discs: In broad terms, this next preferred embodiment of the invention is comprised of the following steps:
This embodiment is prepared identically as in Example 2 with the exception that the inner-phase material constitutes a cosmetic or medicinal preparation such a Retinol or other topical dermal treatment to be applied to the skin. The microcapsules affixed thereto, would release the internal-phase material through tactile pressure, pH change, body temperature, presence of perspiration, or external environmental conditions thus delivering the internal component in the dosage desired, under predetermined release circumstances over a specified time period.

### Example 4

Oven Bag: In broad terms, this next preferred embodiment of the invention is comprised of the following steps:
This embodiment is prepared identically as in Example 1 with the exception that the substrate is a heat-resistant polymer bag or envelope having a surface prepared in such a way that the microcapsules may be securely affixed thereto. An example of this preparation is to etch the surface by chemical or mechanical means to allow for a mechanical bond between the plastic surface and the microcapsule outer-phase material. In the event the microcapsules are prepared prior or independent of the manufacturing process, an additional binder can be used to affix the capsules if needed. The purpose of the embodiment is to allow the latent release of food additives such as color, aroma, vitamins, flavorings or other ingredients or additives that may be suited to this application. To illustrate: A food item is placed in the bag prior to cooking by any convenient and appropriate methods such as convection, boiling or microwave. The microcapsules are affixed in a pattern to the interior of the envelope-bag. They will release their inner-phase components under predetermined conditions which may be a certain range of temperature, the presence of microwave energy, pH change or any other factor that could be used to initiate the rupture of the microcapsules. Upon release, the capsules will deliver flavor, aroma, coloring or even a “grill searing pattern” to the surface of the article of food in accordance with the pattern in which they were affixed to the interior of the cooking bag. This embodiment is particularly useful in the manufacture of pre-prepared frozen foods, especially those cooked by microwave that are otherwise unable to achieve the desirable characteristics imparted by conventional oven cooking.

### Example 5

Flavor cup: In broad terms, this next embodiment of the method is comprised of the following steps:

The next embodiment is also prepared identically as shown in Example 1 with the exception that the substrate is a drinking cup or other beverage container. Ideally, the vessel will be a disposable, one-time use container for use with hot or cold beverages having affixed to the interior wall of said container a layer of microcapsule clusters arranged in a pattern or contiguous layer for the purpose of imparting the additive or primary ingredients to whatever fluid is introduced into the vessel. FIG. 10 shows the interior wall of a common hot beverage cup (A paper coffee cup.) with a pattern of “concentrated instant coffee” microcapsule clusters that have been screen-printed onto the coated paper interior surface. The microcapsule shells are of sufficient strength to allow the cups to be stored in a “nested” stack without inadvertent or premature release of the inner-phase materials due to tactile breakage. However, once a liquid, hot or cold is introduced into the container, the capsules will dissolve thus releasing their contents into the fluid. It is foreseen that this embodiment could be modified for use with most any other type of container including those constructed of materials other than paper such as plastics, styrene, glass, natural fiber and many others into which the internal phase may constitute the entire or partial beverage formulation. Use of plastic, glass or similar materials may require surface activation to securely affix the microcapsules to the substrate as described in EXAMPLE 4. The capsules may contain the ingredients that make up “instant coffee” requiring only the addition of water to create the beverage. The capsules may also contain extracts of high-grade roast coffees. If a lower grade of coffee beverage is introduced into the cup, the high grade extracts will be released thus enhancing the flavor and aroma of the lesser grade blend. Alternatively, the capsules may only contain a flavoring such as cinnamon or even a beverage condiment such as a milk substitute, sugar or both. In the latter case, coffee would then be added releasing the milk substitute and sugar combination creating what is generally recognized as a “regular” cup of the beverage. Having “pre-prepared” cups of this configuration would be particularly useful in coffee vending machines or where coffee is served in an inconvenient location such as by a flight attendant aboard an aircraft saving significant time, space and inventory.

### Example 6

Integrated Delivery Platform (IDP) Cup: In broad terms, this next preferred embodiment of the method is comprised of the following steps:

This embodiment is prepared identically as shown in Example 5. However the utility of this configuration is intended for a variety of pharmaceutical applications. In this preferred embodiment, the cup may be used to orally deliver a broad spectrum of medicinal preparations such as vaccines, vitamins, pain relievers, drugs or any other pharmaceutical compound that would lend itself to this type of delivery. This would be particularly beneficial for those individuals that are unable or otherwise reluctant to ingest pharmaceuticals in pill or tablet form. This invention would also facilitate the administering of vitamins and other medicinal preparations to children as the drug or supplement can be covertly delivered within a beverage more appetizing and familiar to the child. The child's beverage of choice would then become the carrier medium once the latent release of the encapsulated material has occurred. Some practical and beneficial applications would include but are not limited to, children and adult vitamins, cold remedies, teeth whitening systems, dentifrices, aspirin cups, “Alka-Seltzer” cups, disposable vaccine cups and energy drinks.

### Example 7

Indicator Cup: In broad terms, this next preferred embodiment of the invention is comprised of the following steps:

The next preferred embodiment is also prepared identically as shown in Example 5 but is intended to indicate the presence or absence of specific chemicals, elements or compounds by means of an indicating color change reaction similar to conventional pH litmus strips by means of encapsulation of solutions or saturated particles containing indicators such as Roccella Tinctoria. This indication can be accomplished in three specific ways:
1. A color change caused by an indicator or reagent incorporated into the internal or external phase of the affixed microcapsules. Indication color change would occur through permeation, rather than dissolution of the capsule causing the capsules to change color while remaining intact and affixed to the wall of the container.
2. A change in the color of the introduced liquid via release of the indicating agent into the liquid by dissolution of the external phase of the microcapsules affixed to the internal wall.
3. A change in color caused by close proximity or intimate contact to the microcapsule. A representative example of this is a thermally induced color change. While the affixed capsules remain intact and no permeation of the capsule membrane occurs, a thermo-chromic leuco dye indicator may be incorporated into either the inner or outer phase of the microcapsule making the capsule sensitive to change in temperature. These capsules may be affixed to the outer surface of the container if general proximity to the liquid is sufficient. However, this embodiment provides additional utility if heat transfer speed is critical and intimate contact with the liquid is required. Unlike other indicators of this type, segregation is maintained thus preventing the indicator from interacting or contaminating the solution within the disposable container.

The utility of this embodiment becomes obvious particularly in circumstances where the presence or absence of a chemical must be determined and the validity of the sample must be verified at the time of collection. An example of this is a disposable urinalysis drug testing device having a plurality of microcapsules affixed to the interior wall of a paper or plastic collection cup with a percentage of the capsules containing an anti-body dye conjugate and the remainder containing an appropriately calibrated thermo-chromic indicator solution. Upon collection, a color change would occur in the conjugate capsules in the presence of a pre-determined compound or chemical such as THC, a cannabinoid. A similar color change would be evident in the thermally sensitive capsules ensuring that the sample is at human body temperature and was indeed collected immediately from the test subject. Multiple types of indicator capsules may be incorporated into a single cup for a variety of separate tests including those that would otherwise be incompatible processes for simultaneous testing of the same sample in-situ. Many other applications of this embodiment are foreseen and can be configured to indicate potency, concentration, pH or any other instant chemical analysis suited to this method. Uses would include, but are not limited to, drug testing, urinalysis, ketosis testing, pregnancy testing, water safety analysis, pH testing, chemical analysis or any application where an inexpensive, instant, and disposable indicating container would be desirable.

### Example 8

Water Safety Cup: In broad terms, this next preferred embodiment of the invention is comprised of the following steps:
This embodiment is also prepared identically as shown in Example 5 but is intended to provide a means of increasing the potability of water. Various water sanitizing agents such as chlorine, silver and iodine are effective against most harmful bacteria found in untreated water and can be encapsulated for use within the scope of this invention. Of the three sanitizers previously listed, chlorine is the least expensive and most desirable to use. However, it must be delivered in an accurate dosage based on the exact volume of water to be treated which is generally regarded as impractical to implement outside of controlled conditions. This application is where the utility of this embodiment becomes apparent. Because the safety cup contains a known volume of fluid, a precise measure of chlorine sufficient to sanitize the entire quantity may be administered at the time the cup is filled. The microcapsules affixed to the internal wall of the container containing a particulate form of chlorine will dissolve upon contact with water. Sanitization is immediate and the one-time use container is disposable. Alternatively, microcapsules having a latent release time greater than that of the primary sanitizing microcapsules may be affixed to the container wall simultaneously. These secondary capsules may contain chlorine scavengers such as potassium nitrate (saltpeter) or other flavor enhancers to remove any unpleasant after-taste remaining from the initial purification process. This example contemplates configurations specifically designed for the military, international travel, hospitality industry, camping, hiking and other outdoor activities where water is available but potability is in question.

### BRIEF DESCRIPTION OF THE DRAWINGS

FIG. 1

Is an example of a typical basket-type drip coffee maker filter (1) having a multiplicity of microcapsule clusters affixed to the bottom surface, (2) within the pleated filter basket. (3) As shown in the magnified view, (4) The clusters of microcapsules are arranged in such a pattern as to allow the normal filtration of water to prevent an overflow condition through the spaces (5) between clusters (6) and a sufficient volume of flavored additive to prepare an entire pot of coffee. (12 cups)

FIG. 2

A typical flavor disc that has been masked to demonstrate how an image or corporate logo might be “printed” within the microcapsule pattern. The negative image (7) is masked during the screen printing of the capsule clusters (8) thus forming an image within the microcapsule pattern. Colorized images or logos are also possible using multi-colored microcapsules and employing common screen-printing overlay techniques.

FIG. 3

Is a magnified view of an arrangement of microcapsule clusters (9) and the spaces (10) between them on the surface of a paper filter substrate (11).

FIG. 4

Is a significantly magnified profile view of the same microcapsule clusters (12) on a paper substrate (13), clearly showing the individual liquid-filled gelatin micro-spheres (14).

FIG. 5

Diagram of an alternative configuration of the coffee filter using a “cone-shape” filter basket or “Melitta” type filter. (15) The microcapsule clusters (16) are affixed on the interior of the filter envelope but due to the translucency of the filter material (17) are visible from the outside.

FIG. 6

Is a diagram of a conventional tea bag with microcapsule clusters that are capable of containing medicinal ingredients, herbal supplements, flavorings or other beneficial additives (18) affixed to the inside surface of the semi-transparent, fluid-permeable envelope (19).

FIG. 7

Diagram of an individual, single-core, single-walled, liquid filled microcapsule showing both internal (20) and external phases (21).

FIG. 8

A Teflon-coated polypropylene screen mask (22) used to “screen-print” the clusters onto the substrate. The magnified view (23) shows detail of the perforated material. The size of the perforations (24) and thickness of the perforated material (25) may vary to accommodate adjustment of additive delivery volumes. NOTE: The microcapsules may be applied to the substrate surface by several alternative methods including but not limited to, inkjet, spraying, laminating and many others.

FIG. 9

Several typical circular “Flavor Disc” configurations. Note the variety of microcapsule patterns and disc sizes. The disc shape is preferred but any other geometry or cluster pattern may be used provided that its combined surface-area (front and back) is sufficient to support the necessary volume of encapsulated material for delivery. The discs as shown are single-sided.

FIG. 10

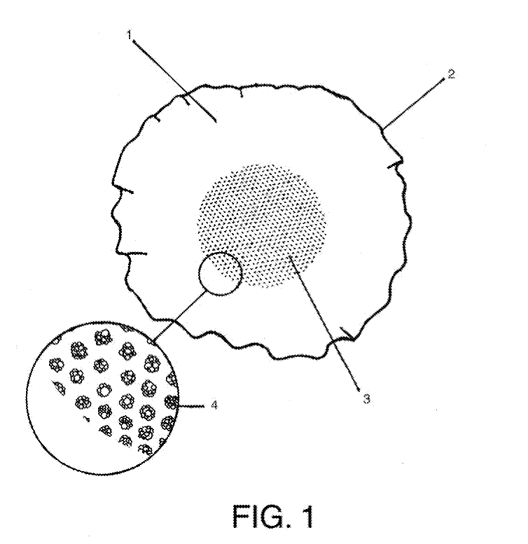

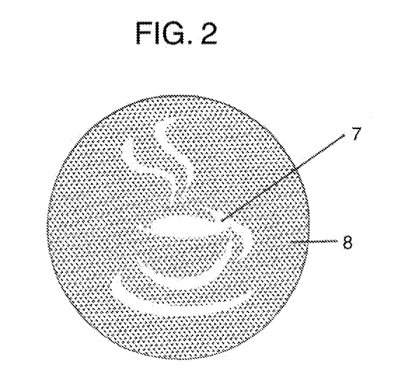

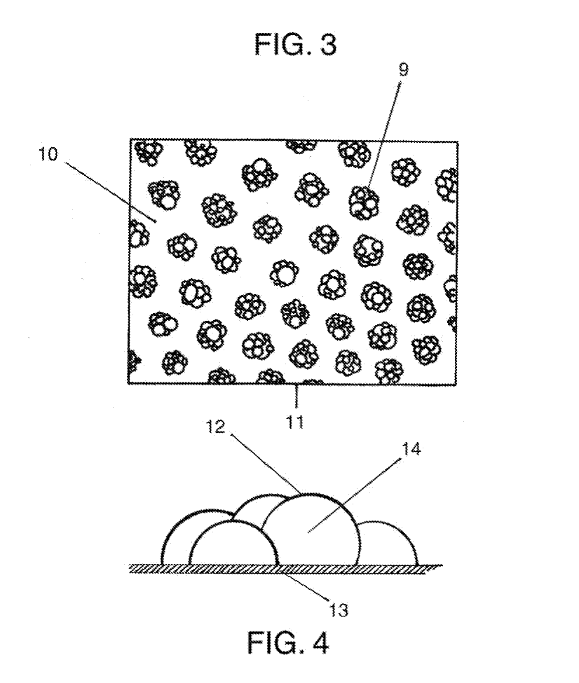

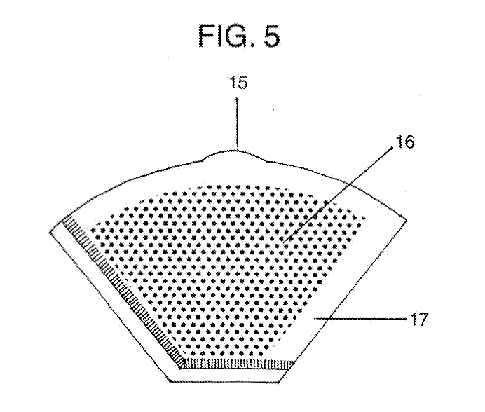

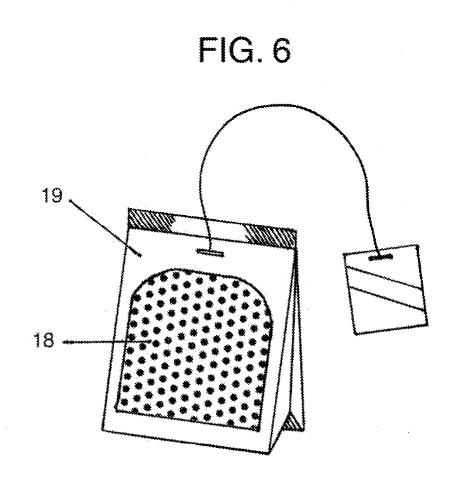

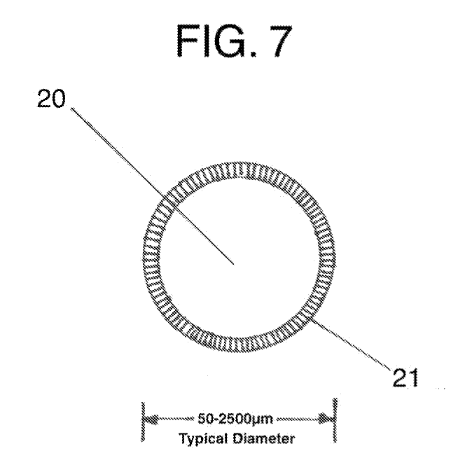

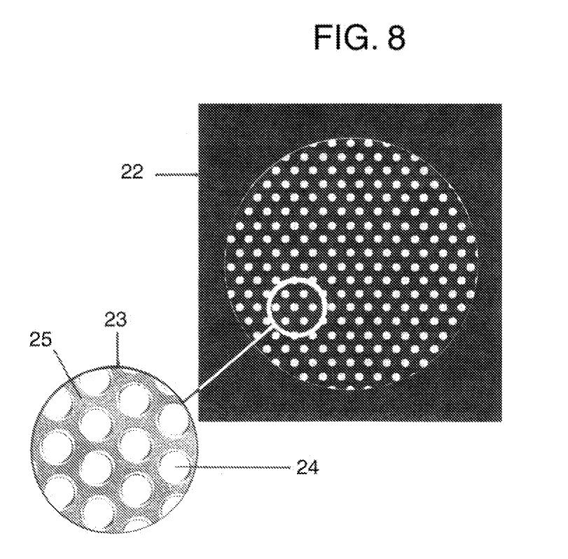

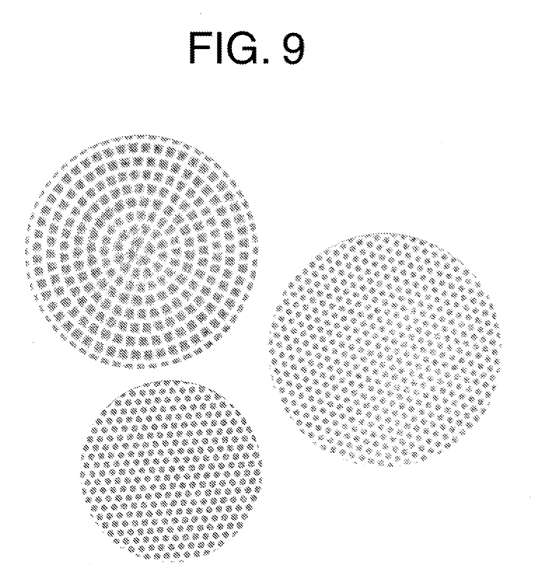

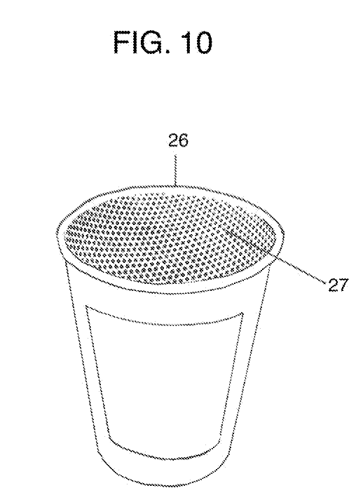

A typical disposable beverage cup (26) with microcapsule clusters containing a concentrated ingredient or additive affixed to the interior wall (27) in a typical pattern. However, the capsules need not be in “clusters” in this instance as the fluid does not pass through the vessel and therefore there is no need to have “spaces” between microcapsule aggregates. The capsules may be affixed in a single contiguous coating if desired and the pattern thickness may be increased or decreased to adjust additive volume and potency.

1. A microencapsulated delivery system, having a multiplicity of microcapsules affixed in a coating, random configuration or pattern to the interior or exterior surface of a cup, container, bottle, filter, package, bag or envelope of any geometry constructed from paper, plastic, glass, cellulose, composites, natural or synthetic fiber or any material suited to affixing capsules thereon for the purpose of latent delivery of various substances such as, but not limited to, flavors, additives, colorants and other ingredients to a liquid, solid or semi-solid placed in intimate or approximate contact with the microcapsule coated surface.

2. A microencapsulated delivery system as described in claim 1, having a plurality of microcapsules for the purpose of latent release of the inner-phase material triggered by, but not limited to, solvent action, enzyme attack, microbial attack, chemical reaction, hydrolysis, shear pressure, melting, disintegration, pH variation or change in temperature.

3. A microencapsulated delivery system as described in claim 1, having the aggregated microcapsules in clusters or individual capsules arranged in a pattern, layer or laminate.

4. A microencapsulated delivery system as described in claim 1, having microcapsules containing, flavors, appearance enhancers, characteristic modifiers, thickeners, catalysts, fragrances, vitamins, minerals, herbs, colorants, de-chlorination scavengers, disinfectants, anti-microbial components, chemical water purifiers, fluoride, dental whiteners, dentifrices of all types, herbal remedies, medicinal ingredients, pain relievers, preservatives, cosmetic preparations, analytical indicators or other additives and modifiers that may be well suited for latent encapsulated delivery.

5. A microencapsulated delivery system as described in claim 1, having microcapsules that contain a preservative and are configured to protect a substance placed within the container from spoilage.

6. A microencapsulated delivery system as described in claim 1, having microcapsules containing various indicator solutions configured to change color indicating that spoilage has occurred or is imminent in a given substance.

7. A microencapsulated delivery system as described in claim 1, having microcapsules derived from edible or non-toxic polymers such as, but not limited to, gelatins, gums, casein, paraffin, sugar or other materials suited for ingredient containment by means of encapsulation.

8. A microencapsulated delivery system as described in claim 1, having the microcapsules affixed to the substrate by means of screen-printing, inkjet printing, laminating, spreading, spraying or any other printing, painting or application method suited to affix a wet or dry micro-particulate material to a substrate surface.

9. A microencapsulated delivery system as described in claim 1, having microcapsules containing a fluid, particulate, solid or semi-solid material.

10. A microencapsulated delivery system as described in claim 1, in which encapsulation occurs as a result of a particulate material being affixed to the substrate with a binding medium such as albumin, starch, gelatin or other edible or non-toxic adhesives known to those skilled in the art.

11. A microencapsulated delivery system having a plurality of microcapsules affixed to the interior of a disposable paper or plastic cup for purpose of latent release of an ingredient or additive to a liquid.

12. A microencapsulated delivery system having a plurality of microcapsules for the purpose of ingredient or additive delivery affixed to the interior or exterior of a disposable filter of any geometry.

13. A disposable container such as a cup or bottle having microcapsules affixed to the interior surface containing chemicals or compounds for the purpose of purifying, sterilizing or de-chlorinating drinking water.

14. A disposable container such as a cup or bottle having microcapsules containing chemicals or compounds affixed to the interior surface that contain the dehydrated ingredients of a beverage, medication or preparation in its entirety or in part.

15. A disposable container such as a dose cup having microcapsules containing pharmaceutical, herbal or medicinal preparations affixed to the interior surface for the purpose of oral delivery of a medication, vitamin, dentifrice or remedy.

16. A disposable container, cup, filter or package having microcapsules containing indicator compounds or reagents affixed to the interior surface for the purpose of detecting certain chemical reactions and indicating the same by means of a color change in either the liquid introduced into the container or the affixed microcapsules when in the presence or absence of certain substances.

17. A disposable brewing filter of any geometry having microcapsules containing flavors, colors, de-chlorinators, purifiers or other additives and modifiers affixed to the interior or exterior surface for latent release or activation during the preparation of coffee, tea or other hot beverage.

18. A disposable filter, cup, container or package having printed, painted, sprayed or otherwise applied microcapsules that have been colorized and arranged to form a pattern, logo, text or decorative image.

19. A microencapsulated delivery system in which the substrate is a paper disc or other geometry having a plurality of microcapsules affixed thereon, containing a cosmetic, medicinal or cosmeceutical preparation for latent delivery caused by one or more of the triggering conditions listed in claim 2 upon dermal contact.

20. A microencapsulated delivery system having a multiplicity of microcapsules affixed to the interior of a microwave or heat resistant cooking bag for the purpose of imparting flavor, aroma, color, decorative pattern or other additives to food during the cooking process.
